(19) United States
(12) Patent Application Publication
(10) Pub. No.: US 2020/0192648 A1
(43) Pub. Date: Jun. 18, 2020

(54) Differential Optimizing Code Transformation

(71) Applicant: EVERYNET BV, The Hague (NL)

(72) Inventors: Igor Shirokov, Saint Petersburg (RU); Vitaly Kleban, Priosersk (Oblast Leningrad) (RU)

(21) Appl. No.: 16/608,704

(22) PCT Filed: Apr. 26, 2017
(86) PCT No.: PCT/EP2017/059846

§ 371 Date: Oct. 25, 2019

(51) Int. Cl. G06F 8/51; G06F 8/70

(52) U.S. Cl. CPC G06F 8/51; G06F 8/70

(57) ABSTRACT

A computer-implemented method for iterative modification of a minification program (T1) for minifying a source code with the following steps: Step 1: Applying the minification program (T1) to an initial source code (A1) to obtain a minified initial source code (F1) and an initial transformation log (L1); Step 2: Applying an intermediate minification program (T′) to the target source code (A2), wherein the intermediate minification program (T′) uses at least the initial identifier renaming dictionary (D1) to obtain an intermediate identifier renaming dictionary (D′), and uses the intermediate identifier renaming dictionary (D′) to minify the target source code (A2) and to obtain an intermediate minified target source code (F′) and an intermediate transformation log (L′), wherein the intermediate transformation log (L′) comprises at least the intermediate identifier renaming dictionary (D′); Step 3: Determining an edit distance (Δ) between the minified initial source code (F1) and the intermediate minified target source code (F′) and checking the edit distance (Δ) against at least one pre-determined stopping criterion; Step 4: Repeating Steps 2 and 3 until the at least one pre-determined stopping criterion is met, wherein every time Step 2 is carried out, a new version of the intermediate identifier renaming dictionary (Dnew) is generated and a new version of the intermediate minified target source code (F′) is obtained; Step 5: After the at least one predetermined stopping criterion is met, obtaining a modified minification program (T2), a minified target source code (F2) and a target transformation log (L2), wherein the target transformation log (L2) comprises at least a target identifier renaming dictionary (D2); Step 6: Outputting the modified minification (T2), the minified target source code (F2) and the target transformation log (L2).

The invention concerns a computer-implemented method for iterative modification of a minification program for minifying a source code, in order to achieve a modified minification program.

Moreover, the invention concerns a computer program comprising instructions which, when the program is executed by a computer, cause the computer to carry out the steps of the method according to the invention.

Furthermore, the invention concerns a computer-readable data carrier comprising a computer program according to the invention.

Furthermore, the invention concerns a data processing device comprising means for carrying out the steps of the method according to the present invention or the computer-readable data carrier according to the present invention.

The method according to the present invention can be applied in the area of wireless communications and, more precisely to the problem of software updates distribution for devices with low memory through low-speed radio channels. The restriction that a communication channel, which is used for distribution of the updates, is designed as a low-speed radio channel makes it expensive (both technically and commercially) to send a complete updated version of a software, e.g. a firmware, through such channel. This type of channels (low-speed radio channels) are quite widely used in such areas as Internet of Things (IoT), where the updates are usually distributed “over-the-air” through Low Power Wide Area Networks (LPWAN: LoRaWAN, SIGFOX, NB-IoT and others). For instance, SIGFOX networks rely on Ultra-Narrow Band (UNB) modulation, and operate in unlicensed sub-GHz frequency bands. Therefore the transmission rate in such IoT networks can usually be as low as 300 bit/sec. Nevertheless, a low transfer rate may sometimes have an advantage. For example packages can be transferred for larger distances in such low transfer rate networks. As a rule of thumb, the lower is the transfer rate of a communication channel, the higher is the transfer distance of a data package, which is sent through the channel. However, such low rates can be extremely disadvantageous if for example a firmware update has to be carried out, if the size of difference data file is large, then the update procedure is time consuming, which can, for example, drastically reduce the lifetime of the battery of the end device (such as a water or an electric meter). For example, automated water meters have batteries that can have a lifetime of about 10 years (a rather long time) and transfer small data packages (e.g. 12 bytes) for example once in a month. For this purpose an LPWAN would be sufficient but if one would need to flash a new firmware on such automated water meter, one may run into trouble, because depending on the size of an firmware update, the whole procedure might take up to one month, which is unfeasible, if one would like to perform it remotely.

There are several objectives of the present invention. One of them is to reduce device time on air, which leads to longer battery life and to a more effective usage of radio spectrum. The more effective usage of radio spectrum makes firmware over the air operation feasible in countries with heavily regulated ISM bands (e.g. EU with RTT&E directive (duty cycle constraints), USA FCC (dwell time restrictions) and other regulations). Another object is to facilitate the process of flashing of a new version of a firmware on devices that are located in areas with very limited access. For instance, water meters may be located in apartments where they cannot be accessed all the time by a technician.

According to the invention, these objectives are achieved by the above-mentioned method comprising following steps:

Step 1: Applying the minification program to an initial source code to obtain a minified initial source code and an initial transformation log.

Step 2: Applying an intermediate minification program to the target source code, wherein the intermediate minification program uses at least the initial identifier renaming dictionary to obtain an intermediate identifier renaming dictionary, and uses the intermediate identifier renaming dictionary to minify the target source code and to obtain an intermediate minified target source code and an intermediate transformation log.

Step 3: Determining an edit distance between the minified initial source code and the intermediate minified target source code and checking the edit distance against at least one pre-determined stopping criterion.

Step 4: Repeating Steps 2 and 3 until the at least one pre-determined stopping criterion is met, wherein every time Step 2 is carried out, a new version of the intermediate identifier renaming dictionary is generated and a new version of the intermediate minified target source code is obtained.

Step 5: After the at least one pre-determined stopping criterion is met, obtaining a modified minification program, a minified (according to the modified minification program) target source code and a target transformation log.

Step 6: Outputting (e.g. by means of storing in a data repository, which may be a part of a storage medium) the modified minification, the minified target source code and the target transformation log.

The computer-implemented method according to the present invention provides the modified minification program that minifies the target source code in a considerably improved and often even in an optimal way, where the considerable improvement or the optimality is achieved with respect to the initial source code and to the minified initial source code. For example, the difference between the minified initial source code and the minified target source code can be expressed as a number of operations that are needed to be performed in order to change the minified initial source code to the minified target source code. In this case the modified minification program produces the minified target source code along with a considerably shorter (and often with the shortest) list of operations needed to transform the minified initial source code to the minified target source code. In this case, instead of sending a common update file, one can send the above-mentioned list of operations as update instructions, which for example may be in a form of an executable code, to a remote device, which has to be updated, and perform the update by carrying out these update instructions on the remote device. Since this list of operations is optimal, the update instructions will have the smallest possible size and, therefore, reduce for example time on air of the remote device. The way how the computer-implemented method according to the present invention works is not restricted to the example, where the difference between the minified initial source code and the minified target source code can be expressed as the number of operations that are needed to be performed in order to change the minified initial source code to the minified target source code. The difference between the minified initial source code and the minified target source code can be expressed in any other suitable way which is a part of common general knowledge, wherein the way how the difference is measured and/or evaluated will influence the way how the minification program is modified. It should be pointed out that the method according to the present invention may be used in any language-processing system (see e.g. “Compilers: Principles, Techniques, & Tools” by A. V. Aho, M. S. Lam, R. Sethi and J. D. Ullmann, Second Edition, Sep. 10, 2006; ISBN-13: 978-0321486813), for example, as part of the preprocessing of such language-processing system.

In a preferred embodiment of the present invention the initial transformation log may comprise at least an initial identifier renaming dictionary and/or the intermediate transformation log may comprise at least the intermediate identifier renaming dictionary and/or the target transformation log may comprise at least a target identifier renaming dictionary. There the renaming can be performed for example by means of shortening.

Moreover, it may be useful if the initial transformation log and/or the intermediate transformation log and/or the target transformation log also comprise(s) an abstract syntax tree.

Advantageously the following steps may be preformed between Step 1 and Step 2 of the method according to the present invention:

Step 1a: Storing, e.g. to a repository, the minified initial source code and the initial transformation log;

Step 1b: Retrieving, e.g. from the repository, the minified initial source code, the initial transformation log, and a target source code. Storing to and retrieving from the repository may be quite useful, when the target source code is not available at the same time. E.g. the initial source code can be a first (beta) version of a program, whereas the target source code may be its next, updated version. Note that both the minified initial source code and the intermediate transformation log could be empty if the target source code is the first available version of software and has no predecessor.

In a preferred embodiment of the invention an intermediate edit sequence from the minified initial source code to the intermediate minified target source code may be determined. Such sequence may comprise a list or sequence of operations that is needed to be performed to transform the minified initial source code to the intermediate minified target source code. Moreover, a target edit sequence may be obtained in Step 5 and outputted (e.g. by means of storing in a repository) in Step 6.

In one preferred embodiment of the invention at least a number of identifiers may be the same in the initial source code and in the target source code, wherein the corresponding entries in the initial identifier renaming dictionary and in the intermediate identifier renaming dictionary corresponding to the same identifiers may be the same as well.

In another preferred embodiment the minification program may perform a first plurality of optimisations (e.g. shortening variable names, removing unreachable branches, removing unused variable definitions, folding (literal) constants, eliminating dead code, etc.) and the intermediate minification program may perform a second plurality of optimisations, wherein the second plurality of optimisations may comprise at least all optimisations from the first plurality of optimisations and may be performed by the intermediate minification program in Step 2, while it minifies the target source code.

The computer-implemented method according to the present invention and to any of invention's embodiments can be realized as instructions contained in a computer program, which instructions, when the program is executed by a computer, cause the computer to carry out the steps of the method according to the present invention. It will be within the understanding of the skilled person that such computer program can be stored on a computer-readable data carrier. The computer that is capable to execute the computer program according to the present invention may be designed as any data processing device, e.g. Smartphone, Laptop, Tablet, PC, etc., comprising means, e.g. at least one processing element, typically a central processing unit (CPU), and/or some form of memory, for executing the computer program or for carrying out the steps of the method according to the present invention. It may also comprise the computer-readable data carrier with the computer program stored on it.

In the following, in order to further demonstrate the present invention, illustrative and non-restrictive embodiments are discussed, as shown in the drawings, which show:

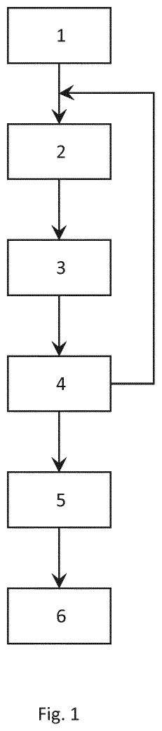

FIG. 1 a flow diagram of a computer-implemented embodiment of the method according to the present invention, and

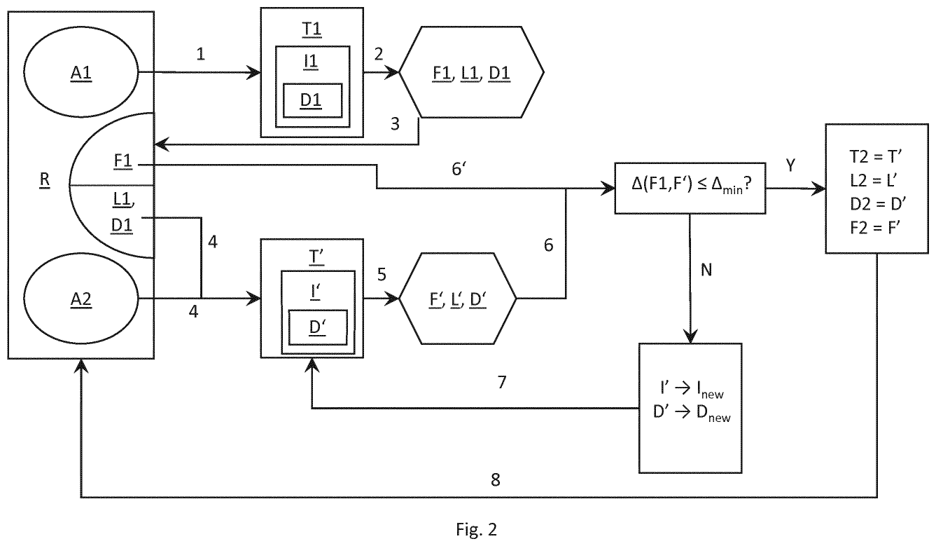

FIG. 2 schematic diagram showing the progress and code instances of the embodiment of the invention.

FIG. 1 depicts a flow diagram illustrating a computer-implemented embodiment of the method according to the present invention. In Step 1 a minification program is applied to an initial source code to obtain an minified initial source code and an initial transformation log, wherein the initial transformation log comprises at least an initial identifier renaming dictionary. The renaming can be carried out, for example, by means of shortening. In Step 2 an intermediate minification program is applied to the target source code, wherein the intermediate minification program uses at least the initial identifier renaming dictionary from Step 1 to obtain an intermediate identifier renaming dictionary, and uses this intermediate identifier renaming dictionary to minify the target source code and to obtain an intermediate minified target source code and an intermediate transformation log, wherein the intermediate transformation log comprises at least the intermediate identifier renaming dictionary. In Step 3 an edit distance between the minified initial source code and the intermediate minified target source code from Step 2 is determined, the said edit distance is then checked against at least one pre-determined stopping criterion (discussed below in greater detail). Step 4 introduces/creates a loop, in which Steps 2 and 3 are repeated, until the at least one pre-determined stopping criterion from Step 3 is met. Every time Step 2 is carried out in this loop, a new version of the intermediate identifier renaming dictionary is generated and a new version of the intermediate minified target source code is obtained. After the at least one pre-determined stopping criterion is met, the loop is left and Step 5 is performed, in which a modified minification program, a minified (by means of the modified minification program) target source code and a target transformation log are obtained. The target transformation log comprises at least a target identifier renaming (e.g. by means of shortening) dictionary. Finally, in Step 6 the modified minification program, the minified target source code and the target transformation log are made available (e.g. stored on a medium) as an output (for example to a user of to some other computer-implemented method or program for further processing).

FIG. 2 shows a schematic diagram of a method which corresponds to a preferred embodiment of a method for iterative modification of a minification program T1 according to the present invention. It should be noted that this method includes all technical features of the method discussed above with regard to FIG. 1. The minification program may be stored in a repository (not shown) and applied to a source code. Usually there are two (different) versions of a source code: an initial version A1 (initial source code) and a target version A2 (target source code). Both versions of the source code A1 and A2 may also be stored in a repository R (not necessarily at the same time), which can be a part of a computer-readable data carrier, e.g. of a storage medium. Here both the initial source code A1 and the target source code A2 are stored in the same repository R. It will, however, be clear that they can be stored in different repositories and on different storage media (not shown). In the first step of the method according to this embodiment the initial source code A1 is retrieved from a repository (arrow 1) and the minification program T1 is applied to it to achieve an minified initial source code F1 (arrow 2). It will be within the understanding of the skilled person that the minification program may or may not be stored in the same repository R. It may be stored in some other repository, e.g. on some other storage medium. Moreover, the minification program T1 may be of the form of an executable machine code. Furthermore, the minification program T1 may comprise an initial list/sequence of instructions I1. The initial list of instructions I1 may be designed, for example, as a sequence of computer-executable commands. The minification program T1 is capable of transforming the initial source code A1 according to the initial list of instructions I1 and, for example, performs transformation of the initial source code A1 according to the sequence of computer-executable commands. The initial instructions I1 may, for example, comprise an instruction, according to which the names (lexemes) of the identifiers in the target source code A1 will be renamed (e.g. shortened) according to an initial identifier renaming dictionary D1. After the minified initial source code F1 is obtained along with an initial transformation log L1, the minified initial source code F1, the initial transformation log L1 and the initial identifier renaming dictionary D1 may be passed to and stored in the repository R (arrow 3). The initial identifier renaming dictionary D1 and/or the initial list of instructions I1 may be contained in the initial transformation log L1. Note that at the time, when the minified initial source code F1, the initial transformation log L1 and the initial identifier renaming dictionary D1 are stored in the repository R, the target source code A2 may not be stored in the repository R. The target source code A2 may not even exist at this moment. For example, the initial source code A1 may be an initial (beta) version of some computer program, whereas the target source code A2 may be the next (e.g. updated and/or bug-fixed) version of that program, which may not yet exist at the moment of the minification of the initial source code A1. At the moment when the target source code A2 is available (or has been made available) in the repository R it may be passed as an input to an intermediate minification program T′. Furthermore, the intermediate minification program T′ receives at least the initial transformation log L1 and the initial identifier renaming dictionary D1 as inputs (arrows 4). The minified initial source code may be also passed to the intermediate minification program as a part of the input (not shown). The initial transformation log L1 and the initial identifier renaming dictionary D1 form a “feedback” for modifying the minification program T1. The minification program T1 is modified to the intermediate minification program T′ (first iteration) in such a way that, unlike the minification program T1, the intermediate minification program T′ is capable of taking an extended input, i.e. not only a source code (e.g. the target source code A2 or the initial source code A1) but also some other information relevant with regard to the minification procedure (e.g. the initial transformation log L1, the initial identifier renaming dictionary D1, the minified initial source code F1 and so on), and to minify the source code, e.g. the target source code A2, depending on the information content of the extended input. The intermediate minification program T′ may for example, comprise steps of extracting the initial list of instructions I1 from the initial transformation log L1, constructing an intermediate list/sequence of instructions I′ from the initial list of instructions I1 and minifying the target source code A2 according to at least the intermediate list of instructions I′, wherein the intermediate list of instructions I′ may be designed as a sequence of computer-executable commands. In this way the intermediate minification program T′ minifies the target source code A2 depending on how the minification program T1 has minified the initial source code A1. The intermediate minification program T′ may, therefore, use the information contained in the extended input (e.g. the initial transformation log L1 and/or in the initial identifier renaming dictionary D1) as a priori information in order to improve its output—an intermediate minified target source code F′. The output may be improved, for example, with regard to the amount of changes that are needed to be performed on the minified initial source code F1 in order to achieve the intermediate minified target source code F′. The intermediate minification program T′ may also comprise for example the intermediate list/sequence of instructions I′. The intermediate list of instructions I′ may comprise a plurality of commands, which may be executable by a computer and, when the plurality of commands is executed by a computer the target source code A2 is transformed to the intermediate minified target source code F′. The intermediate list of instructions I′ may for example comprise an intermediate identifier renaming dictionary D′ in order to shorten names/lexemes of the identifiers in the target source code A2. It may be sometimes useful, if the intermediate list of instructions I′ comprises all instructions of the initial list of instructions I1. The intermediate identifier renaming dictionary D′ may comprise at least a fraction of entries from the initial identifier renaming dictionary D1. This may be useful, especially, in the case that the target source code A2 is an update of the initial source code A1 and comprises a number of identifiers from the initial source code A1. In this case an entry for an identifier, which is the same in the initial source code A1 and in the target source code A2, may be the same in the initial identifier renaming dictionary D1 and in the intermediate identifier renaming dictionary D′. This allows that identifiers that have the same names in the minified initial source code F1 and in an intermediate minified target source code F′ actually correspond to the same meaning in the initial source code A1 and in the target source code A2. The intermediate minification program T′ produces an output (arrow 5), which may comprise the intermediate minified target source code F′ and an intermediate transformation log L′, wherein the intermediate identifier renaming dictionary D′ may be also a part of the intermediate transformation log L′ and therefore of the output of the intermediate minification T′.

After the intermediate minification program T′ was carried out on the target source code A2, an edit distance Δ between the minified initial source code F1 and the intermediate minified target source code F′ is determined, denoted by Δ(F1,F′) (arrows 6, 6′). For that matter one may retrieve the minified initial source code F1 from the repository (arrow 6′) or pass it along with the initial transformation log L1 and the initial identifier renaming dictionary D1 to the intermediate minification program T′ as an input (not shown), while, for example, making the determining of the edit distance Δ between the minified initial source code F1 and the intermediate minified target source code F′ a part of the intermediate list of instructions I′ of the intermediate minification program T′. Preferably, the Levenshtein distance is used as the edit distance. However, one may use other derivatives of the edit distance, e.g. the longest common subsequence (LCS) distance, which can be derived from the edit distance, by allowing insertion and deletion to be the only two edit operations, both at unit cost, or the Hamming distance, which can be obtained by allowing only substitutions (again at unit cost), or Jaro-Winkler distance that can be obtained from the edit distance where only transpositions are allowed. Thereafter the edit distance Δ (or one of its derivatives) is checked against at least one pre-determined stopping criterion, such as a pre-determined number of search attempts (iterations), exceeding a pre-determined threshold of the edit distance Δₘᵢₙ (as shown in FIG. 2), a threshold on the edit distance's decreasing rate over search attempts (iterations).

If the value of the edit distance Δ does not exceed the pre-determined value Δₘᵢₙ, then the intermediate minification program T′ may be considered as the desired modified minification program T2. In this case branch Y (for “yes”) in FIG. 2 is used. The intermediate minified target source code F′, the intermediate transformation log L′ and the intermediate identifier renaming dictionary D′ may be then considered as the minified target source code F2, the target transformation log L2 and is the target identifier renaming dictionary D2. The target identifier renaming dictionary D2 may be contained in the target transformation log L2. If the value of the edit distance Δ exceeds the pre-determined value Δₘᵢₙ, then the intermediate minification program T′ is not “good enough” yet. In this case a new intermediate list of instructions I_{new} and/or a new intermediate identifier renaming dictionary D_{new} may be generated and used to replace the intermediate list of instructions I′ and/or the intermediate identifier renaming dictionary D′, which were used by the intermediate minification program T′ (branch N (for “no”) in FIG. 2). In this way the intermediate minification program T′ is modified. Note that the modification of the intermediate program T′ is not restricted to generation of the new intermediate list of instructions I_{new} and/or the new intermediate identifier renaming dictionary D_{new}. It is also possible provide a new or modified abstract syntax tree or modify the intermediate transformation log L1 at the input of the intermediate minification program T′. The modification of the intermediate minification program represents a second iteration of the modification of the minification program T1. Thereafter the intermediate minification program T′ minifies the target source code A2 according to the new intermediate list/sequence of instructions I_{new} and/or uses the new intermediate identifier renaming dictionary D_{new} (for example, when it preforms shortening of the lexemes of the identifiers contained in the target source code A2). While constructing the new intermediate list of instructions I_{new} and/or the new intermediate identifier renaming dictionary D_{new} it can be useful to use the knowledge of the previous intermediate list of instructions and intermediate identifier renaming dictionary. However, one can also just discard the intermediate list of instructions and/or the intermediate identifier renaming dictionary that led to an undesired edit distance and generate or construct the new intermediate list of instructions and/or the new intermediate identifier renaming dictionary just from the initial list of instructions I1, the initial identifier renaming dictionary D1 and the initial transformation log L1.

After running the intermediate minification program T′ with the new intermediate list of instructions I_{new} and/or the new intermediate identifier renaming dictionary D_{new} on the target source code A2, it may be useful to compare the edit distance between a new intermediate minified target source code and the minified initial source code F1, denoted by Δ(F1,F_{new}), not only with the pre-determined value Δₘᵢₙ but also with the edit distance between the minified initial source code F1 and the intermediate minified target source code F′, denoted by Δ(F1,F′). If Δₘᵢₙ Δ(F1,F_{new}) Δ(F1,F′) holds, one may consider and use the new intermediate list of instructions I_{new} and/or a new intermediate identifier renaming dictionary D_{new}, in the next iteration step.

As a result, the modified minification program T2 generates the minified target source code F2, which has an optimal (for example the smallest) edit distance to the initial source code F1 with regard to the at least one stopping criterion.

It should be noted that the above described procedure also works when the initial source code A1 is empty. In this case the target source code A2 represents an initial, first version of the code. In this special case and trivial it is not necessary to modify the minification program T1, so that the modification of the minification program T1 is a trivial one—namely there is no modification of the minification program T1 at all.

The described preferred embodiment of the present invention as well as the invention itself can be implemented in a variety of real-life situations and is not restricted to the above mentioned implementations (e.g. firmware updates for water and/or electric meters). It can be used in for example in SmartHomes, or for updating firmware of computers, such as PCs, or mobile devices or for software updates in general (and not only in over-the-air applications).

1. A computer-implemented method for iterative modification of a minification program for minifying a source code, in order to achieve a modified minification program, the method comprising the following steps:
Step 1: Applying the minification program to an initial source code to obtain a minified initial source code and an initial transformation log;
Step 2: Applying an intermediate minification program to a target source code, wherein the intermediate minification program uses at least the initial identifier renaming dictionary to obtain an intermediate identifier renaming dictionary, and uses the intermediate identifier renaming dictionary to minify the target source code and to obtain an intermediate minified target source code and an intermediate transformation log;
Step 3: Determining an edit distance between the minified initial source code and the intermediate minified target source code and checking the edit distance against at least one pre-determined stopping criterion;
Step 4: Repeating Steps 2 and 3 until the at least one pre-determined stopping criterion is met, wherein every time Step 2 is carried out, a new version of the intermediate identifier renaming dictionary is generated and a new version of the intermediate minified target source code is obtained;
Step 5: After the at least one pre-determined stopping criterion is met, obtaining a modified minification program, a minified target source code and a target transformation log;
Step 6: Outputting the modified minification, the minified target source code and the target transformation log.

2. The computer-implemented method according to claim 1, wherein the initial transformation log comprises at least an initial identifier renaming dictionary and/or the intermediate transformation log includes at least the intermediate identifier renaming dictionary and/or the target transformation log includes at least a target identifier renaming dictionary.

3. The computer-implemented method according to claim 2, wherein the initial transformation log and/or the intermediate transformation log and/or the target transformation log also include(s) an abstract syntax tree.

4. The computer-implemented method according to claim 1, wherein following steps are preformed between Step 1 and Step 2:
Step 1a: Storing the minified initial source code and the initial transformation log;
Step 1b: Retrieving the minified initial source code, the initial transformation log, and the target source code.

5. The computer-implemented method according to claim 1, wherein in Step 3 an intermediate edit sequence from the minified initial source code to the intermediate minified target source code is determined, which sequence includes a list of operations that is needed to be performed in order to transform the minified initial source code to the intermediate minified target source code; in Step 5 a target edit sequence is obtained, and in Step 6 the target edit sequenced is outputted.

6. The computer-implemented method according to claim 1, wherein at least a number of identifiers are the same in the initial source code and in the target source code, and the corresponding entries in the initial identifier renaming dictionary and in the intermediate identifier renaming dictionary corresponding to the same identifiers are the same.

7. The computer-implemented method according to claim 1, wherein the minification program performs a first plurality of optimizations and the intermediate minification program performs a second plurality of optimizations, wherein the second plurality of optimizations includes at least all optimizations from the first plurality of optimizations and is performed by the intermediate minification program in Step 2, while it minifies the target source code.

8. A computer program comprising instructions which, when the program is executed by a computer, cause the computer to carry out the steps of the method of claim 1.

9. A computer-readable data carrier comprising a computer program according to claim 8.

10. A data processing device comprising means for carrying out the steps of the method of claim 1.
